(19) United States
(12) Patent Application Publication
(10) Pub. No.: US 2018/0341966 A1
(43) Pub. Date: Nov. 29, 2018

(54) SYSTEM AND METHOD FOR PROMOTING PRODUCT SALES BY USING DISTRIBUTION OF SALES PROFIT ACCORDING TO EVENT SUCCESS

(71) Applicant: SV INC., Seoul (KR)

(72) Inventors: Yong Hyun Kang, Suwon-si (KR); Du Hyun Kim, Seoul (KR)

(21) Appl. No.: 16/054,905

(22) Filed: Aug. 3, 2018

Related U.S. Application Data
(63) Continuation of application No. PCT/KR2017/000761, filed on Jan. 23, 2017.

(30) Foreign Application Priority Data
Feb. 6, 2016 (KR) 10-2016-0015339
Apr. 22, 2016 (KR) 10-2016-0049633

(51) Int. Cl. G06Q 30/02

(52) U.S. Cl. CPC G06Q 30/0215; G06Q 30/0234; G06Q 30/0211; G06Q 30/0238

(57) ABSTRACT

A system includes an event configuration unit through which a seller's terminal inputs at least one among a sales price of a product, a target period of selling the product, and a target quantity of the product to be sold, configures an event to be successful when the target quantity of the product is sold during the target period of selling the product, and inputs at least one among the amount of a distribution profit to be distributed to the purchaser when the event is successful, a distribution scheme of the distribution profit, and a distribution rate of the distribution profit; a product payment unit through which the purchaser's terminal makes a payment for the product; an event management unit for activating the event, and identifying whether the number of payments for the product having been made through the product payment unit, meets the target quantity of the product to be sold; and a profit distribution unit for paying the distribution profit to purchasers when the event management unit identifies that the event is successful.

### CROSS-REFERENCE TO RELATED APPLICATION(S)

This patent document claims priority to and the benefit of PCT Application No. PCT/KR2017/000761 filed on Jan. 23, 2017 which claims priorities to Korean Patent Application No. 10-2016-0015339 filed on Feb. 6, 2016 and Korean Patent Application No. 10-2016-0049633 filed on Apr. 22, 2016. The above applications are all hereby incorporated by reference for all purposes as if fully set forth herein.

### TECHNICAL FIELD

Some implementations of the disclosed technology relate to a product sales promotion system and method.

### BACKGROUND

A consumption behavior in a conventional economic system is carried out by paying for a product in cash to obtain the product. Under such a structure, as more consumption is made, the cash assets of a consumer are reduced, so that the consumer has to stop or cut down his or her consumption so as to increase or maintain his or her cash assets.

If an economic depression occurs, the consumer reduces his or her consumption, and thus, product sales are reduced. Subsequently, product sellers reduce the number of workers or their wage due to the decrease of their sales, and therefore, the consumer's income becomes reduced, so that he or she reduces the consumption more and more, thereby making such a vicious circle to be repeated under such a structure.

If the cash assets of the consumer are increased as he or she increases consumption, however, the opposite phenomena to those mentioned above may occur. In detail, the consumer increases his or her consumption more, and accordingly, product sales are drastically increased. Also, the product sellers increase the number of workers or their wage through the drastic increase of their sales. Therefore, the consumer's income increase as well, which allows his or her consumption to increase as well. If such an economic system is achieved and continued, the world economy will be in the boom years.

### SUMMARY

Various implementations are provided to introduce a unique manner of distributing a portion of sales profit to purchasers, if a product selling event configured by a seller is successful, to increase the cash assets of the purchasers, so that the product sales are promoted.

Some implementation of the disclosed technology provides a product sales promotion system including: an event configuration unit adapted to allow at least one of sales price of a product, a target period of time for product sales, a target amount of product sales to be inputted thereto through a terminal of a seller, to allow an event which is successful when the target amount of product sales is achieved for the target period of time for the product sales to be configured thereon through the terminal of the seller, and to allow at least one of an amount of distribution profit to be distributed to purchasers who purchase the product when the event is successful, a distribution way of the distribution profit, and a distribution rate of the distribution profit to be inputted thereto through the terminal of the seller; a product payment unit adapted to allow a payment for the product to be made through a terminal of the purchaser; an event management unit for activating the event and checking whether the number of payments for the product made by the product payment unit reaches the target amount of product sales; and a profit distribution unit for paying the distribution profit to the purchasers, when it is checked by the event management unit that the event is successful.

In some implementations, before the event is activated, the event management unit may transfer an event notification message of notifying a member joining in the product sales promotion system of a start date and a start time of the event activation to the terminal of the member.

In some implementations, the event management unit may activate the event after a given period of a standby time from a start time of the event activation.

In some implementations, the event configuration unit may receive a guaranteed amount lower than the sales price of the product from the terminal of the seller, and the payment made in the event management unit may be the payment for the guaranteed amount or for the sales price.

In some implementations, the product sales promotion system may further include: a system account unit for depositing the amount made by the payment; and a member account unit applied to the member joining in the product sales promotion system to allow at least one of cyber money and cash to be deposited thereinto.

In some implementations, before or at the same time the event activation starts, an event deposit of the seller having the same amount as the distribution profit may be transferred from the member account unit of the seller into the system account unit.

In some implementations, the event management unit may transfer a sales price additional payment request to a terminal of the a purchaser who makes a payment only for the guaranteed amount (hereinafter, referred to as “guaranteed amount payment purchaser”), and when the guaranteed amount payment purchaser make a sales price additional payment through the terminal in the product payment unit, the event management unit may transfer the amount corresponding to the guaranteed amount from the amount deposited into the system account unit into the member account unit of a guaranteed amount payment purchaser who make the sales price additional payment (hereinafter, referred to as “sales price additional payment purchaser”).

In some implementations, the product sales promotion system may further include a delivery management unit for transferring a delivery address of a purchaser who makes a payment for the sales price, without a payment for the guaranteed amount (hereinafter, referred to as “sales price payment purchaser”) and a delivery address of the sales price additional payment purchaser to the terminal of the seller.

In some implementations, the product sales promotion system may further include a purchase confirmation management unit for transferring a purchase confirmation request to the terminal of the sales price payment purchaser and the terminal of the sales price additional payment purchaser to receive the response to the purchase confirmation request from the terminal of the sales price payment purchaser and the terminal of the sales price additional payment purchaser, wherein when the response to the purchase confirmation request is a purchase cancel response, the profit distribution unit may transfer the amount corresponding to the sales price to the member account units of the sales price payment purchaser and the sales price additional payment purchaser, and when it is checked by the event management unit that the event is successful, the profit distribution unit may transfer the amount calculated by subtracting the amount corresponding to the guaranteed amount from the sales price to the member account units of the sales price payment purchaser and the sales price additional payment purchaser.

In some implementations, the product sales promotion system may further include a purchase confirmation management unit for transferring a purchase confirmation request to the terminal of the sales price payment purchaser and the terminal of the sales price additional payment purchaser to receive the response to the purchase confirmation request from the terminal of the sales price payment purchaser and the terminal of the sales price additional payment purchaser, wherein when the response to the purchase confirmation request is a purchase cancel response, the profit distribution unit may transfer the amount calculated by subtracting the amount corresponding to the guaranteed amount from the sales price to the member account units of the sales price payment purchaser and the sales price additional payment purchaser, and when it is checked by the event management unit that the event fails, the profit distribution unit may transfer the amount corresponding to the guaranteed amount to the member account units of the sales price payment purchaser and the sales price additional payment purchaser.

In some implementations, the product sales promotion system may further include a purchase confirmation management unit for transferring a purchase confirmation request to the terminal of the sales price payment purchaser and the terminal of the sales price additional payment purchaser to receive the response to the purchase confirmation request from the terminal of the sales price payment purchaser and the terminal of the sales price additional payment purchaser, wherein when the response to the purchase confirmation request is a purchase confirmation response and when it is checked by the event management unit that the event is successful, the profit distribution unit may determine individual distribution profits to be distributed to the sales price payment purchaser and the sales price additional payment purchaser who perform the purchase confirmation response (hereinafter, referred to as “purchase confirmation purchasers”) by applying the distribution way of the distribution profit and the distribution rate of the distribution profit to the distribution profit, and the profit distribution unit may transfer the individual distribution profits from the amount kept in the system account unit into the member account units of the purchase confirmation purchasers.

In some implementations, the product sales promotion system may further include a minimum guaranteed amount calculation unit for notifying the terminal of the seller of a minimum guaranteed amount, when the event configuration unit receives the guaranteed amount from the terminal of the seller, the minimum guaranteed amount being calculated by dividing the largest amount among the individual distribution profits calculated when the event is successful into the target amount of product sales.

In some implementations, the product sales promotion system may further include a minimum guaranteed amount calculation unit for notifying the terminal of the seller of a minimum guaranteed amount, when the event configuration unit receives the guaranteed amount from the terminal of the seller, the minimum guaranteed amount being calculated by dividing the event deposit into the target amount of product sales.

In some implementations, the distribution way of the distribution profit may include the steps of: arranging the purchase confirmation purchasers in the order of payment; paying a first individual distribution profit calculated by multiplying the distribution profit and the distribution rate of the distribution profit to a first purchase confirmation purchaser who performs the most rapid payment among the purchase confirmation purchasers; and paying a second individual distribution profit calculated by multiplying the amount remaining by subtracting the first individual distribution profit from the distribution profit and the distribution rate of the distribution profit to a second purchase confirmation purchaser who performs the most rapid payment in the second order among the purchase confirmation purchasers.

In some implementations, the member account unit may include a cyber money account in which cyber money is deposited, and the distribution way of the distribution profit includes the steps of: arranging the purchase confirmation purchasers in the order of a value calculated by multiplying the cyber money amount of the cyber money accounts of the purchase confirmation purchasers and the number of payments of the purchase confirmation purchasers (hereinafter, referred to as “cyber money amount for order”); paying a first individual distribution profit calculated by multiplying the distribution profit and the distribution rate of the distribution profit to a first purchase confirmation purchaser who has the largest cyber money amount for order among the purchase confirmation purchasers; and paying a second individual distribution profit calculated by multiplying the amount remaining by subtracting the first individual distribution profit from the distribution profit and the distribution rate of the distribution profit to a second purchase confirmation purchaser who has the largest cyber money amount for order in the second order among the purchase confirmation purchasers.

In some implementations, the distribution way of the distribution profit may include the steps of: arranging the purchase confirmation purchasers in the order of sales price payment; paying a first individual distribution profit calculated by multiplying the distribution profit and the distribution rate of the distribution profit to a first purchase confirmation purchaser who performs the most rapid sales price payment among the purchase confirmation purchasers; and paying a second individual distribution profit calculated by multiplying the amount remaining by subtracting the first individual distribution profit from the distribution profit and the distribution rate of the distribution profit to a second purchase confirmation purchaser who performs the most rapid sales price payment in the second order among the purchase confirmation purchasers.

In some implementations, the distribution way of the distribution profit may include the steps of: arranging the purchase confirmation purchasers in the order of purchase confirmation response; paying a first individual distribution profit calculated by multiplying the distribution profit and the distribution rate of the distribution profit to a first purchase confirmation purchaser who performs the most rapid purchase confirmation response among the purchase confirmation purchasers; and paying a second individual distribution profit calculated by multiplying the amount remaining by subtracting the first individual distribution profit from the distribution profit and the distribution rate of the distribution profit to a second purchase confirmation purchaser who performs the most rapid purchase confirmation response in the second order among the purchase confirmation purchasers.

In some implementations, when the payment is performed, the profit distribution unit may transfer expected distribution order in which the purchasers who perform the payment are arranged in order according to the distribution way of the distribution profit to the terminals of the purchasers who perform the payment.

In some implementations, the expected distribution order may be made by arranging the purchasers who perform the payment in the order of the payment.

In some implementations, the expected distribution order may be made by arranging the purchasers who perform the payment in the order of a value obtained by multiplying the cyber money amount deposited into the cyber money accounts included in the member account units of the purchaser who performs the payment and the number of payments.

In some implementations, the expected distribution order may be made by arranging the purchasers who perform the payment in the order of the sales price payment.

In some implementations, the expected distribution order may be made by arranging the purchasers who perform the payment in the order of the purchase confirmation response of the purchasers who perform the payment with respect to the purchase confirmation request transferred from the purchase confirmation management unit to the terminals of the purchasers who perform the payment.

Some implementation of the disclosed technology provides a product sales promotion method including the steps of: (a) inputting at least one of sales price of the product, a target period of time for product sales, a target amount of product sales to an event configuration unit through a terminal of the seller; (b) configuring an event which is successful when the target amount of product sales is achieved for the target period of time for product sales on the event configuration unit through the terminal of the seller, and inputting at least one of an amount of distribution profit to be distributed to the purchasers when the event is successful, a distribution way of the distribution profit, and a distribution rate of the distribution profit to the event configuration unit through the terminal of the seller; (c) activating the event through an event management unit; (d) performing a payment for the product by a terminal of the purchaser through a product payment unit; (e) checking whether the number of payments for the product made by the product payment unit reaches the target amount of product sales, through the event management unit; and (f) paying the distribution profit to the purchasers through a profit distribution unit when it is checked by the event management unit that the event is successful.

In some implementations, the product sales promotion method may further include, before the step (c), the step of transferring an event notification message that notifies a member joining in the product sales promotion system of a start date and a start time of the event activation to the terminal of the member, through the event management unit.

In some implementations, the step (c) may include the step of activating the event after a given period of a standby time from a start time of the event activation, through the event management unit.

In some implementations, the product sales promotion method may further include, before the step (c), the step of receiving a guaranteed amount lower than the sales price of the product from the terminal of the seller, through the event configuration unit, and the payment made in the event management unit is the payments for the guaranteed amount or for the sales price.

In some implementations, the product sales promotion method may further include, before or at the same time the step (c), the step of transferring an event deposit of the seller having the same amount as the distribution profit from the member account unit of the seller into a system account unit.

In some implementations, the product sales promotion method may further include, after the step (d), the step of depositing the amounts made by the payments into the system account unit.

In some implementations, the step (d) may include the steps of: allowing the terminal of the purchaser to make a payment for the guaranteed amount of the product, through the product payment unit; transferring a sales price additional payment request to the terminal of the purchaser who makes a payment only for the guaranteed amount (hereinafter, referred to as “guaranteed amount payment purchaser”), through the event management unit; allowing the terminal of the guaranteed amount payment purchaser to make a sales price additional payment, through the product payment unit; and transferring the amount corresponding to the guaranteed amount from the amount deposited into the system account unit to the member account unit of the guaranteed amount payment purchaser who makes the sales price additional payment (hereinafter, referred to as “sales price additional payment purchaser”).

In some implementations, the product sales promotion method may further include, after the step (d), the step of transferring a delivery address of the purchaser who makes a payment for the sales price to purchase the product (hereinafter, referred to as “sales price payment purchaser”) and a delivery address of the sales price additional payment purchaser to the terminal of the seller, through a delivery management unit.

In some implementations, the product sales promotion method may further include, after the step (d), the steps of: transferring a purchase confirmation request to the terminal of the sales price payment purchaser and the terminal of the sales price additional payment purchaser, through a purchase confirmation management unit; receiving the response to the purchase confirmation request from the terminal of the sales price payment purchaser and the terminal of the sales price additional payment purchaser through the purchase confirmation management unit; and when the response to the purchase confirmation request is a purchase cancel response, transferring the amount corresponding to the sales price to the member account units of the sales price payment purchaser and the sales price additional payment purchaser, through the profit distribution unit, and when it is checked by the event management unit that the event is successful, transferring the amount calculated by subtracting the amount corresponding to the guaranteed amount from the amount corresponding to the sales price to the member account units of the sales price payment purchaser and the sales price additional payment purchaser, through the profit distribution unit.

In some implementations, the product sales promotion method may further include, after the step (d), the steps of: transferring a purchase confirmation request to the terminal of the sales price payment purchaser and the terminal of the sales price additional payment purchaser, through a purchase confirmation management unit; receiving the response to the purchase confirmation request from the terminal of the sales price payment purchaser and the terminal of the sales price additional payment purchaser, and when the response to the purchase confirmation request is a purchase cancel response, transferring the amount calculated by subtracting the amount corresponding to the guaranteed amount from the sales price to the member account units of the sales price payment purchaser and the sales price additional payment purchaser, through the profit distribution unit, and when it is checked by the event management unit that the event fails, transferring the amount corresponding to the guaranteed amount to the member account units of the sales price payment purchaser and the sales price additional payment purchaser, through the profit distribution unit.

In some implementations, the product sales promotion method may further include, after the step (d), the steps of: transferring a purchase confirmation request to the terminal of the sales price payment purchaser and the terminal of the sales price additional payment purchaser, through a purchase confirmation management unit; and receiving the response to the purchase confirmation request from the terminal of the sales price payment purchaser and the terminal of the sales price additional payment purchaser through the purchase confirmation management unit, wherein the step (f) includes the steps of: when a purchase confirmation response is received through the purchase confirmation management unit and when it is checked by the event management unit that the event is successful, determining individual distribution profits to be distributed to the sales price payment purchaser and the sales price additional payment purchaser who perform the purchase confirmation response (hereinafter, referred to as “purchase confirmation purchasers”) by applying the distribution way of the distribution profit and the distribution rate of the distribution profit to the distribution profit, through the profit distribution unit; and transferring the individual distribution profits from the amount kept in the system account unit into the member account units of the purchase confirmation purchasers, through the profit distribution unit.

In some implementations, the product sales promotion method may further include the step of notifying the terminal of the seller of a minimum guaranteed amount, before the step of receiving the guaranteed amount lower than the sales price from the terminal of the seller through the event configuration unit, the minimum guaranteed amount being calculated by dividing the largest amount among the individual distribution profits calculated when the event is successful into the target amount of product sales.

In some implementations, the product sales promotion method may further include the step of notifying the terminal of the seller of a minimum guaranteed amount, before the step of receiving the guaranteed amount lower than the sales price from the terminal of the seller through the event configuration unit, the minimum guaranteed amount being calculated by dividing the event deposit into the target amount of product sales.

In some implementations, the distribution way of the distribution profit may include the step of: arranging the purchase confirmation purchasers in the order of payment; paying a first individual distribution profit calculated by multiplying the distribution profit and the distribution rate of the distribution profit to a first purchase confirmation purchaser who performs the most rapid payment among the purchase confirmation purchasers; and paying a second individual distribution profit calculated by multiplying the amount remaining by subtracting the first individual distribution profit from the distribution profit and the distribution rate of the distribution profit to a second purchase confirmation purchaser who performs the most rapid payment in the second order among the purchase confirmation purchasers.

In some implementations, the distribution way of the distribution profit may include the step of: arranging the purchase confirmation purchasers in the order of a value calculated by multiplying the cyber money amount of the cyber money accounts of the purchase confirmation purchasers and the number of payments of the purchase confirmation purchaser (hereinafter, referred to as “cyber money amount for order”); paying a first individual distribution profit calculated by multiplying the distribution profit and the distribution rate of the distribution profit to a first purchase confirmation purchaser who has the largest cyber money amount for order among the purchase confirmation purchasers; and paying a second individual distribution profit calculated by multiplying the amount remaining by subtracting the first individual distribution profit from the distribution profit and the distribution rate of the distribution profit to a second purchase confirmation purchaser who has the largest cyber money amount for order in the second order among the purchase confirmation purchasers.

In some implementations, the distribution way of the distribution profit may include the step of: arranging the purchase confirmation purchasers in the order of sales price payment; paying a first individual distribution profit calculated by multiplying the distribution profit and the distribution rate of the distribution profit to a first purchase confirmation purchaser who performs the most rapid sales price payment among the purchase confirmation purchasers; and paying a second individual distribution profit calculated by multiplying the amount remaining by subtracting the first individual distribution profit from the distribution profit and the distribution rate of the distribution profit to a second purchase confirmation purchaser who performs the most rapid sales price payment in the second order among the purchase confirmation purchasers.

In some implementations, the distribution way of the distribution profit may include the step of: arranging the purchase confirmation purchasers in the order of purchase confirmation response; paying a first individual distribution profit calculated by multiplying the distribution profit and the distribution rate of the distribution profit to a first purchase confirmation purchaser who performs the most rapid purchase confirmation response among the purchase confirmation purchasers; and paying a second individual distribution profit calculated by multiplying the amount remaining by subtracting the first individual distribution profit from the distribution profit and the distribution rate of the distribution profit to a second purchase confirmation purchaser who performs the most rapid purchase confirmation response in the second order among the purchase confirmation purchasers.

In some implementations, the step (d) may include the step of transferring expected distribution order in which the purchasers who perform the payment are arranged in order according to the distribution way of the distribution profit to the terminals of the purchasers who perform the payment, through the profit distribution unit, when the payment is performed.

In some implementations, the expected distribution order may be made by arranging the purchasers who perform the payment in the order of the payment.

In some implementations, the expected distribution order may be made by arranging the purchasers who perform the payment in the order of a value obtained by multiplying the cyber money amount deposited into the cyber money accounts included in the member account units of the purchaser who performs the payment and the number of payments.

In some implementations, the expected distribution order may be made by arranging the purchasers who perform the payment in the order of the sales price payment.

In some implementations, the expected distribution order may be made by arranging the purchasers who perform the payment in the order of the purchase confirmation response of the purchasers who perform the payment with respect to the purchase confirmation request transferred from the purchase confirmation management unit to the terminals of the purchasers who perform the payment.

According to the implementations of the disclosed technology, a mechanism is provided for distributing a portion of sales profit to the purchasers, if the product selling event configured by the seller is successful, to increase the cash assets of the purchasers, so that the product sales are promoted.

### BRIEF DESCRIPTION OF THE DRAWINGS

FIG. 1 is an exemplary view showing a configuration of a product sales promotion system according to an implementation of the disclosed technology.

FIG. 2 is an exemplary view showing processes of selling products and distributing sales profit in the product sales promotion system according to an implementation of the disclosed technology, wherein a purchaser makes a payment for the guaranteed amount on an event configured by a seller and performs a purchase confirmation response.

FIG. 3 is an exemplary view showing processes of selling products and distributing sales profit in the product sales promotion system according to an implementation of the disclosed technology, wherein a purchase confirmation management unit at step S230 of FIG. 2 receives a purchase cancel response from a sales price additional payment purchaser.

FIG. 4 is an exemplary view showing processes of selling products and distributing sales profit in the product sales promotion system according to an implementation of the disclosed technology, wherein the purchaser makes a payment for the sales price on the event configured by the seller and performs the purchase confirmation response.

FIG. 5 is an exemplary view showing processes of selling products and distributing sales profit in the product sales promotion system according to an implementation of the disclosed technology, wherein the purchase confirmation management unit at step S500 of FIG. 4 receives the purchase cancel response from the purchaser who makes a payment for the sales price.

### DETAILED DESCRIPTION

Hereinafter, various implementations of the disclosed technology will be described in detail with reference to the accompanying drawings so that those skilled in the art can easily carry out the disclosed technology. In the following detailed description of the embodiments of the disclosed technology, a detailed description of known functions or configurations will be omitted. The same reference numerals are used throughout the drawings for portions having similar functions and actions. Hereinafter, a product sales promotion system and method according to an embodiment of the present invention will now be described in detail with reference to the attached drawings.

In addition, in the entire specification, when a part is referred to as being “connected” with another part, it is not only a case where it is directly connected, but also a case where it is indirectly connected with another element therebetween. Also, “comprising” and “including” mean that other components may be included, rather than excluding other components, unless specifically stated otherwise.

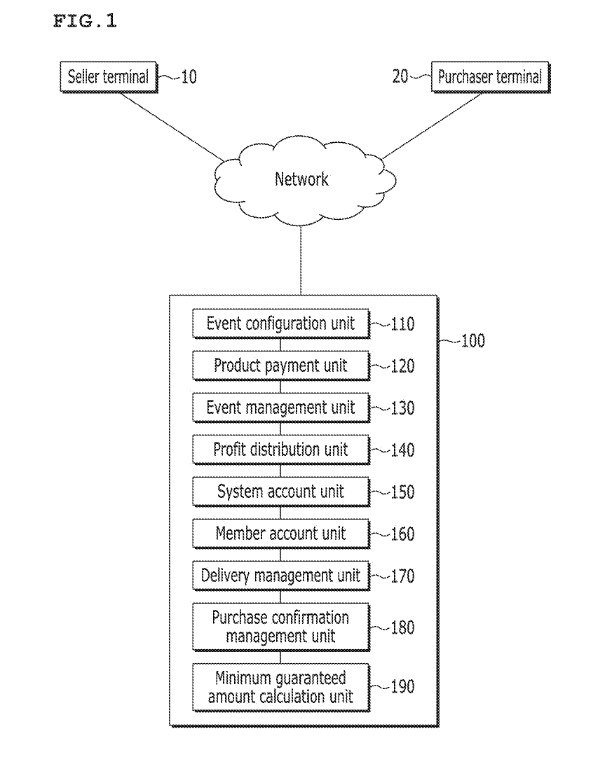

FIG. 1 is an exemplary view showing a configuration of a product sales promotion system according to an implementation of the disclosed technology.

A product sales promotion system 100 according to an implementation of the disclosed technology may include an event configuration unit 110, a product payment unit 120, an event management unit 130, a profit distribution unit 140, a system account unit 150, a member account unit 160, a delivery management unit 170, a purchase confirmation management unit 180, and a minimum guaranteed amount calculation unit 190.

The term “unit” as used herein may include software, hardware, or a combination thereof depending on the context in which the term is used. For example, the software may be machine code, firmware, embedded code, application software, or a combination thereof. Also, for example, the hardware may be a circuit, a processor, a computer, an integrated circuit, integrated circuit cores, or a combination thereof. The units may be implemented in one computer in some applications, or may be distributed in more than one computers or servers linked to a communication network to allow communications between the units.

A seller may be connected to the product sales promotion system 100 by using a seller terminal 10 through wired and wireless network. A purchaser may be connected to the product sales promotion system 100 by using a purchaser terminal 20 through the wired and wireless network. The seller terminal 10 and the purchaser terminal 20 may be or include devices for transmitting and receiving data to and from the product sales promotion system 100 connected thereto, and for example, desktop computers, laptops, smart phones, tablet computers, and so on may be used as the seller terminal 10 and the purchaser terminal 20. However, the seller terminal 10 and the purchaser terminal 20 are not limited to those mentioned above. The produce sales promotion system 100 which is communicatively connected with the seller terminal 10 and the purchaser terminal 20 to receive relevant information from the seller terminal and/or the purchaser terminal 20.

The seller and the purchaser are members who join in the product sales promotion system 100, and the members of the product sales promotion system 100 have cyber money accounts and cash accounts connected to their own accounts. The cyber money accounts and the cash accounts are included in the member account unit 160. The cyber money deposited into the cyber money accounts may be used to decide distribution amounts for the respective purchasers. Thus, the cyber money deposited into the cyber money accounts may provide a distribution standard for distributing a distribution profit as will be discussed later, and the distribution profit is put into the cyber money accounts in the form of cyber money. The cash in the cash accounts may be transferred into the cyber money accounts, exchanged with the cyber money in the ratio of 1:1 or in other predetermined ratio, and deposited into the cyber money accounts. Contrarily, the cyber money in the cyber money accounts may be transferred into the cash accounts, but in this case, desirably, a withdrawal fee at a given rate for the transferring money has to be paid. The withdrawal fee may be transferred into the system account unit 150 of the product sales promotion system 100, and the cash may be transferred into the cash accounts of the members. The cyber money may include reward points, mileages, coupons, credits, gifts, incentives, energy currency, etc.

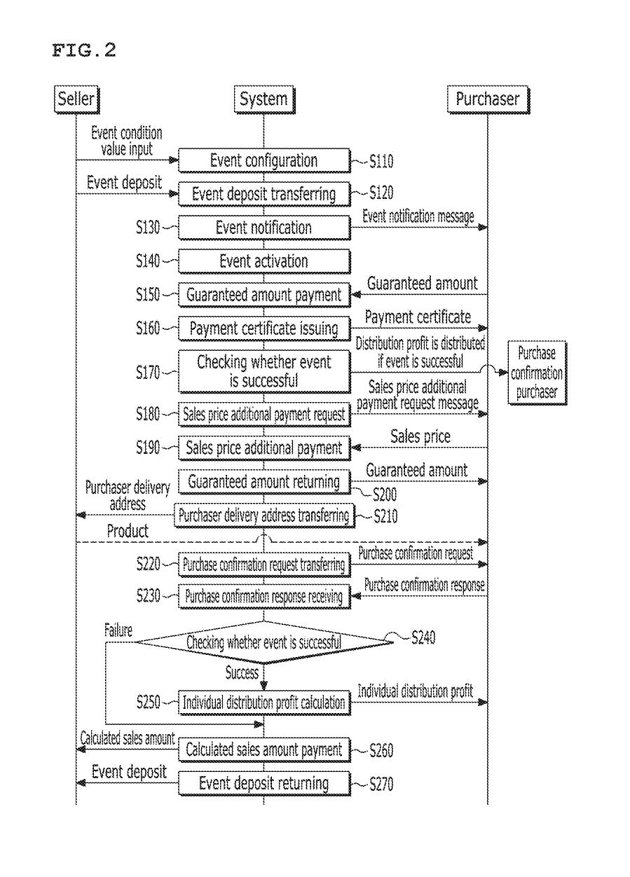

FIG. 2 is an exemplary view showing processes of selling products and distributing sales profit in the product sales promotion system according to an implementation of the disclosed technology, wherein a purchaser makes a payment for the guaranteed amount on an event configured by a seller and performs a purchase confirmation response.

The seller terminal 10 is connected to the product sales promotion system 100, and provide, to the product sales promotion system 100, event information on a sales event that a seller wishes to set by, for example, selecting an event configuration menu. The event information provided from the seller terminal 10 the product sales promotion system 100 may include at least one of event condition values, the sales price of a product that the seller wishes to sell, the target period of time for product sales, the target amount of product sales, a guaranteed amount, a distribution profit to be distributed to the purchasers who have purchased and received purchase confirmation when the event determined as successful, a distribution way of the distribution profit, and/or a distribution rate of the distribution profit. In some implementations, the event configuration unit 110 operates to display, on the seller terminal 10, an input screen which allows the seller terminal 10 provide the corresponding event information. The event information provided to the event configuration unit 110 from the seller terminal 10 is stored in the event configuration unit 110, thereby completing configuring the event (at step S110). Some of the event information is used to determine whether the event set by the seller terminal 10 is successful or not. In some implementations, the product sales promotion system 100 may determine an event as successful when a target amount of product sales is achieved for a target period of time for product sales.

Having the guaranteed amount for a product in addition to the sales price of the product, allows to reduce the payment burden on the purchasers. The guaranteed amount may be set less than the sales price, and the purchaser who wants to purchase the product may make a payment for the whole sales price of the product or for the guaranteed amount. If the payment for the sales price of the product or for the guaranteed amount is made, a payment certificate is issued by the event management unit 130. The payment certificate can be designed in various manners, for example, including a barcode for a respective purchaser, and If the number of payment certificates reaches the target amount of product sales, it is considered that the event is successful. The purchaser may make a payment for the total sales price of the product or only for the guaranteed amount so as to join in the event.

The event information such as the sales price of the product, the target period of time of product sales, the target amount of product sales, the guaranteed amount, the distribution profit, the distribution way of the distribution profit, and/or the distribution rate of the distribution profit may be arbitrarily determined by and received from the seller terminal 10. The product sales promotion system 100 may operate to provide some suggestions with appropriate values for at least some of the event information. In some implementations, the product sales promotion system 100 may include algorithms to calculate optimized values of some event information in advance and provide the calculated values to the seller terminal 10.

The minimum guaranteed amount calculation unit 190 may calculate a minimum guaranteed amount, and the calculated minimum guaranteed amount may be transferred to the seller terminal 10. The minimum guaranteed amount calculation unit 190 may perform the calculation of the minimum guaranteed amount based on various algorithms. Some of the algorithms are further discussed below.

In some implementations, the minimum guaranteed amount calculation unit 190 may calculate the minimum guaranteed amount as a value which is obtained by dividing the greatest distribution profit among the distribution profits distributed to the purchaser terminals 20 by the target amount of product sales. The different distribution profits are distributed to the respective purchaser terminals 20 when the event is determined as successful. The minimum guaranteed amount calculation unit 190 may provide the minimum guaranteed amount to the seller terminal 10. In response, if the seller terminal 10 selects, for a particular sales event that the seller is setting through the event configuration unit 110, the minimum guaranteed amount as provided from the product sales promotion system 100 (i.e., the greatest distribution profits/the target amount of product sales), even when all other purchasers cancel their purchases except only the purchaser who is supposed to have the largest individual distribution profit, the seller can still pay the individual distribution profit with the guaranteed amount to the purchaser, without any damages to the seller.

In some implementations, the minimum guaranteed amount calculation unit 190 may calculate the minimum guaranteed amount as a value which is obtained by dividing an event deposit by the target amount of product sales. The event deposit is the amount of money deposited by the seller terminal 10 for a particular sales event and more explanations are provided later. As mentioned below, if the purchaser cancels his/her purchase after the event is determined as successful, the product sales promotion system 100 operates to return the amount calculated by subtracting the guaranteed amount from the sales price to the purchaser, and the guaranteed amount is paid to the seller regardless of the cancellation of the purchase. If the seller terminal 10 selects, for a particular sales event that the seller is setting through the event configuration unit 110, the minimum guaranteed amount as provided from the product sales promotion system (i.e., the event deposit/the target amount of product sales), even if all of the purchasers cancel their purchase after the event is determined as successful, the whole guaranteed amount that is the same as the event deposit is paid to the seller, so that the seller can receive the event deposit back, without any damage.

In response to receiving the event information from the seller terminal 10, the event management unit 130 transfers. to the seller terminal 10, a message that the amount corresponding to the distribution profits to be distributed to the purchaser terminals 20 needs to be deposited into the system account unit 150 as an event deposit. Through the seller terminal 10, the seller requests the event management unit 130 to transfer the event deposit having the same amount as the distribution profit from the cyber money account or cash account connected to the seller's account into the system account unit 150, and the event management unit 130 transfers the event deposit from the cyber money account or cash account of the seller into the system account unit 150 (at step S120). The cash is transferred into the system account unit 150, and in case where the cash is transferred as the event deposit from the cyber money account into the system account unit 150, the withdrawal fee occurs so that the amount corresponding to the event deposit and the withdrawal fee is withdrawn from the cyber money account.

Before the event is activated, the event management unit 130 may transfer an event notification message notifying the terminals of the members enrolled or registered in the product sales promotion system 100 of the start date and start time of the event activation (at step S130). As the start date and start time of the event activation are in advance notified, it is possible to substantially increase the number of users who participate the event provided by the product sales promotion system 100. The event notification message that notifies the members of the event activation can ensure fairness in sales where the distribution of the distribution profits is made according to the order of payment (for example, the payment certificate issue order), the order of sales price payment, or the order of purchase confirmation response. As a result, the event notification message can prevent the first occupation in the distribution order of the distribution profit by the purchasers who in advance obtain the event information.

In some implementations, before the activation of the event, the event management unit 130 may notify the members of a period of time for a possible start date of the event activation instead of the exact particular start date. In this case, it is possible to start the activation of the event within the period of time without any further notice. For example, the event management unit 130 may notify the members of a period of time, for example, between May 1, 2016 and May 8, 2106, for a possible start date, and without any additional notification, the event may be activated on May 3, 2016, 1 pm.

The event management unit 130 activates the event configured through the event configuration unit 110 by the seller terminal 10 of the seller (at step S140). Before the event is activated by the seller, the event management unit 130 requests the seller terminal 10 to deposit a system usage fee, and if it is checked that the system usage fee is deposited into the system account unit 150, the event management unit 130 activates the event.

In some implementations, the event is activated without sending any event notification message to the members enrolled or registered in the product sales promotion system 100. Thus, the event notification message can be omitted before the activation of the event and it is possible that the event is activated on the start date and time of the event, without any notification.

The event management unit 130 may activate the event after a given period of standby time from the start time of the event, not on the exact start time of the event set in the event configuration unit 110 through the seller terminal 10 of the seller. In case where the distribution of the distribution profit is made according to the order of payment (for example, the payment certificate issue order), the order of sales price payment, or the order of purchase confirmation response, accordingly, fairness can be ensured. During the given period of standby time, the members can be provided the opportunities to obtain the event information, thereby preventing some purchasers who obtain the event information in advance from taking the advantages in the distribution order of the distribution profit.

If the event is activated, the product can be purchased through the purchaser terminal 20 of the purchaser. The purchaser may make a payment only for the guaranteed amount or for the total sales price of the product. Hereinafter, an explanation on the case where the purchaser makes a payment only for the guaranteed amount will be given.

To purchase the product, the purchaser makes a payment using the purchaser terminal 20 for the guaranteed amount on the payment screen provided through the product payment unit 120, and the product payment unit 120 deposits the paid guaranteed amount into the system account unit 150 (at step S150). The paid guaranteed amount is the cash withdrawn from the cyber money account or cash account of the purchaser, card sales amount received from a credit card company of the purchaser, and payment amount received from a smart phone communication company of the purchaser. The payment may be made in various ways including online/offline payment ways, and a detailed explanation on the payment ways will be omitted.

If the payment for the guaranteed amount is made, the event management unit 130 issues the payment certificate and transfers the payment certificate to the purchaser terminal 20 (at step S160).

After the event management unit 130 issues the payment certificates for the respective purchasers, the event management unit 130 checks whether the event is successful (at step S170). In some implementations, the event management unit 130 compares the target amount of product sales provided from the seller terminal 10 with the total amounts of the payment certificates that have been issued. If the target amount of product sales is equal to or less than that the total amounts of the payment certificates that have been issued, the event management unit 130 determines that the event is successful. If the event is determined as successful, the product sales promotion system 100 proceeds to distribute the distribution profit to appropriate purchasers The distribution of the distribution profit will be explained later.

The event management unit 130 transfers an additional payment request message to the purchaser terminal 20 of the purchaser (hereinafter, referred to as “purchaser with guaranteed amount payment”) who makes a payment only for the guaranteed amount (at step S180). The timing when the additional payment request message is sent can be modified in various manners. For example, the additional payment request message may be sent before the step 170, or after the step 170.

In response to receiving the additional payment request, the purchaser with guaranteed amount payment may make a payment for a sales price of the product. For this, the product payment unit 120 of the product sales promotion system 100 provides the payment screen to the purchaser terminal 20 (at step S190). If the additional payment for the sales price is not made by the purchaser terminal 20 corresponding to the purchaser with the guaranteed amount payment within a period of time, the event management unit 130 determines that the purchaser with guaranteed amount payment does not wish to complete the purchase and cancel his/her purchase, and the guaranteed amount paid from the purchaser with guaranteed amount payment may be provided to the cash account of the seller at the moment or after the event is finished.

If the purchaser with the guaranteed amount payment makes the payment for the sales price, the event management unit 130 returns the guaranteed amount which was already paid to the guaranteed amount payment purchaser (hereinafter, referred to as “purchaser with additional payment”) at step S200. The guaranteed amount is withdrawn from the amount kept in the system account unit 150 and is transferred into the cash account of the purchaser with additional payment.

The delivery management unit 170 transfers, to a seller terminal, a delivery address and a payment certificate for the purchaser with additional payment to allow the seller to deliver the product to the purchaser with additional payment (at step S210). A delivery can be made in various manners, for example, through a delivery service or a direct delivery from the seller to the purchaser. If the product is delivered directly to the purchaser, the seller may scan bar codes on the payment certificate provided to the purchaser with additional payment.

The purchase confirmation management unit 180 transfers a purchase confirmation request to the purchaser with additional payment who receives the product through the delivery service or directly receives the product from the seller (at step S220).

The purchase confirmation management unit 180 receives the response to the purchase confirmation request from the purchaser with additional payment (at step S230). The response to the purchase confirmation request is either the purchase confirmation response or the purchase cancel response. Hereinafter, an explanation on the case where the response to the purchase confirmation request is the purchase confirmation response will be given.

If the purchase confirmation management unit 180 receives the purchase confirmation response from the purchaser with additional payment, the event management unit 130 checks whether the event is successful (at step S240). As discussed above, the event management unit 130 previously checks whether the event is successful at the step 170. If the determination was made at step 170 as successful, the determination at step 240 may be omitted. If the determination was made at step 170 as not successful, the event management unit 130 checks again at step 240 that the event is successful or not. The event management unit 130 may make a comparison between the total amounts paid by the purchasers, which are obtained based on the number of the payment certificates issued by the payments (inclusive of the sales price payments and the guaranteed amount payments) for the products, and the target amount of product sales. If the event management unit 130 determines that the event is successful, the profit distribution unit 140 pays an individual distribution profit in cyber money to the purchaser with additional payment who responded to the purchase confirmation management unit 180 with the purchase confirmation response (at step S250). The profit distribution unit 140 determines and calculates the distribution profit. For this, the profit distribution unit 140 may apply algorithms and determine the distribution rate for the purchaser with additional payment. The individual distribution profit is withdrawn from the amount kept in the system account unit 150 and is transferred into the cyber money account of the purchaser with additional payment. The distribution profit is paid in cyber money, but it is possible that the distribution profit is transferred, in cash, into the cash account of the purchaser with additional payment.

After the individual distribution profit is paid to the purchasers through the profit distribution unit 140 (at the step S250), the event management unit 130 transfers the sales amount calculated by subtracting the sum of the paid individual distribution profits from the total sales amount (calculated by multiplying the sales price and the number of purchase confirmed products) into the cash account of the seller (at step S260) and returns the event deposit in the system account unit 150 to the cash account of the seller (at step S270). In this case, an explanation on the steps S250, S260 and S270 which are sequentially performed is paid, but the steps may be performed concurrently or in a reverse order to each other.

If it is determined by the event management unit 130 that the number of payment certificates issued by the payments (inclusive of the sales price payments and the guaranteed amount payments) for the products does not reach the target amount of product sales (at the step S240), it is determined that the event fails. If the event fails, the step of distributing the individual distribution profit (at the step S250) is not performed.

If the event fails, the event management unit 130 transfers the total sales amount (calculated by multiplying the sales price and the number of purchase confirmed products) into the cash account of the seller (at the step S260) and returns the event deposit in the system account unit 150 to the cash account of the seller (at the step S270). In this case, an explanation on the steps S260 and S270 which are sequentially performed is paid, but the steps may be performed concurrently or in a reverse order to each other.

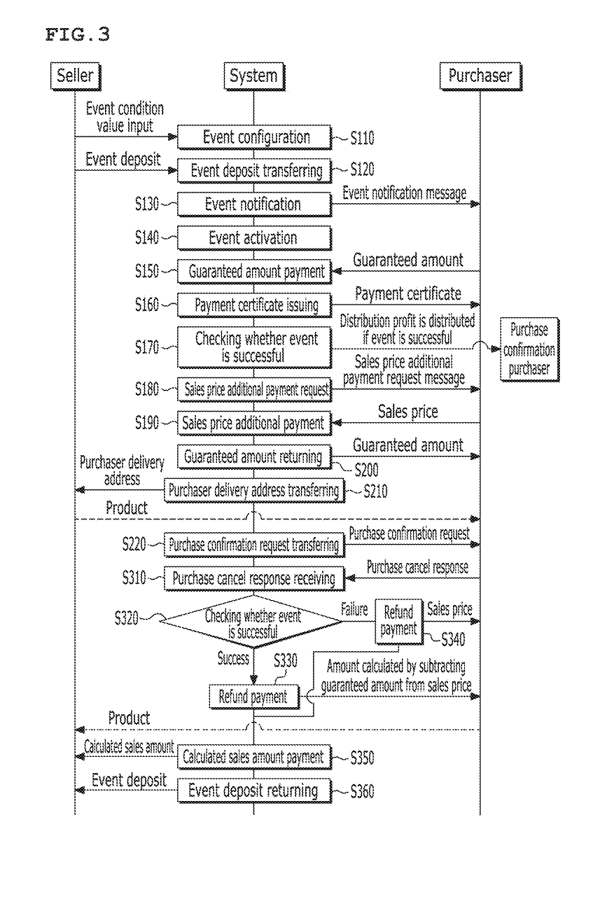

FIG. 3 is an exemplary view showing the case where the purchase confirmation management unit 180 at the step S230 of FIG. 2 receives the purchase cancel response from the purchaser with additional payment. Since the steps S110 to S220 are the same as FIG. 2, an explanation on them will be omitted, and accordingly, the step S230 of FIG. 2 (corresponding to step S310 of FIG. 3) and the steps after the step S230 will be explained below.

The purchase confirmation management unit 180 transfers the purchase confirmation request to the purchaser with additional payment (at the step S220).

The purchase confirmation management unit 180 receives the response to the purchase confirmation request from the purchaser with additional payment (at the step S230). The response to the purchase confirmation request is either the purchase confirmation response or the purchase cancel response. Hereinafter, an explanation on the case where the response to the purchase confirmation request is the purchase cancel response will be given. The purchase cancel response is the purchaser's willingness to get a refund.

If the purchase confirmation management unit 180 receives the purchase cancel response from the purchaser with additional payment (at step S310), the event management unit 130 checks whether the event is successful (at step S320). If the event management unit 130 may make a comparison between the total amount paid by the purchasers, which are obtained based on the number of the payment certificates issued by the payments (inclusive of the sales price payments and the guaranteed amount payments) for the products, and the target amount of product sales. If the target amount of product sales is equal to or less than the total amount paid by the purchasers, the event management unit 130 determines that the event is successful, and if the target amount of product sales is greater than the total amount paid by the purchasers, the event management unit 130 determines that the event is not successful and fails.

If it is determined at step 320 that the event is successful, the profit distribution unit 140 pays the amount calculated by subtracting the guaranteed amount from the sales price, as a refund, to the purchaser with additional payment who sent the purchase cancel response (at step S330). The refund is withdrawn from the amount kept in the system account unit 150 and is thus transferred into the cash account of the purchaser with additional payment who sent the purchase cancel response. The guaranteed amount is not returned to the purchaser with additional payment and used to pay the distribution profit according to the event success to other purchasers. Under this configuration, if the purchaser with additional payment cancels his/her purchase and the event successes, his or her guaranteed amount is not returned. Bo doing so, the system can discourage the purchasers not to cancel his/her purchase.

After the profit distribution unit 140 pays the individual distribution profits to the purchasers who perform the purchase confirmation response, the event management unit 130 pays the sales amount calculated by subtracting the sum of the paid individual distribution profits from the total sales amount (calculated by multiplying the sales price and the number of purchase confirmed products) to the cash account of the seller (at step S350) and returns the event deposit in the system account unit 150 to the cash account of the seller (at step S360).

In the above, it has been explained that the purchase confirmation management unit 180 receives the purchase cancel response from the purchaser with additional payment (at the step S310), and after the event management unit 130 checks that the event is successful (at the step S320), the profit distribution unit 140 may pay the refund calculated by subtracting the guaranteed amount from the sales price to the purchaser with additional payment who responded with the purchase cancel response (at the step S330). In some implementation, the order of some operations could be changed and the process proceeds in different manners. For example, when the purchase confirmation management unit 180 receives the purchase cancel response from the purchaser with additional payment, the profit distribution unit 140 may directly pay the refund calculated by subtracting the guaranteed amount from the sales price to the purchaser with additional payment who responded with the purchase cancel response, and then, the event management unit 130 checks whether the event is successful. If it is checked that the event is successful, the guaranteed amount is not additionally paid to the purchaser with additional payment who responded with the purchase cancel response. The guaranteed amount might be paid to the purchaser. If the event fails (at the step S320), the profit distribution unit 140 pays the amount corresponding to the sales price as the refund to the purchaser with additional payment who responded with the purchase cancel response (at step S340). The refund is withdrawn from the amount kept in the system account unit 150 and is thus transferred into the cash account of the purchaser with additional payment who responded with the purchase cancel response.

The event management unit 130 pays the total sales amount (calculated by multiplying the sales price and the number of purchase confirmed products) to the cash account of the seller (at the step S350) and returns the event deposit in the system account unit 150 to the cash account of the seller (at the step S360).

In the above, it has been described that the purchase confirmation management unit 180 receives the purchase cancel response from the purchaser with additional payment (at the step S310), and after the event management unit 130 checks that the event fails (at the step S320), the profit distribution unit 140 pays the refund corresponding to the sales price to the purchaser with additional payment who responded with the purchase cancel response (at the step S340). In some implementations, when the purchase confirmation management unit 180 receives the purchase cancel response from the purchaser with additional payment, the profit distribution unit 140 firstly pays the refund (calculated by subtracting the guaranteed amount from the sales price) to the purchaser with additional payment who responded with the purchase cancel response, and then, the event management unit 130 checks whether the event is successful. If it is checked that the event fails, the guaranteed amount may be secondarily paid to the purchaser with additional payment who responded with the purchase cancel response.

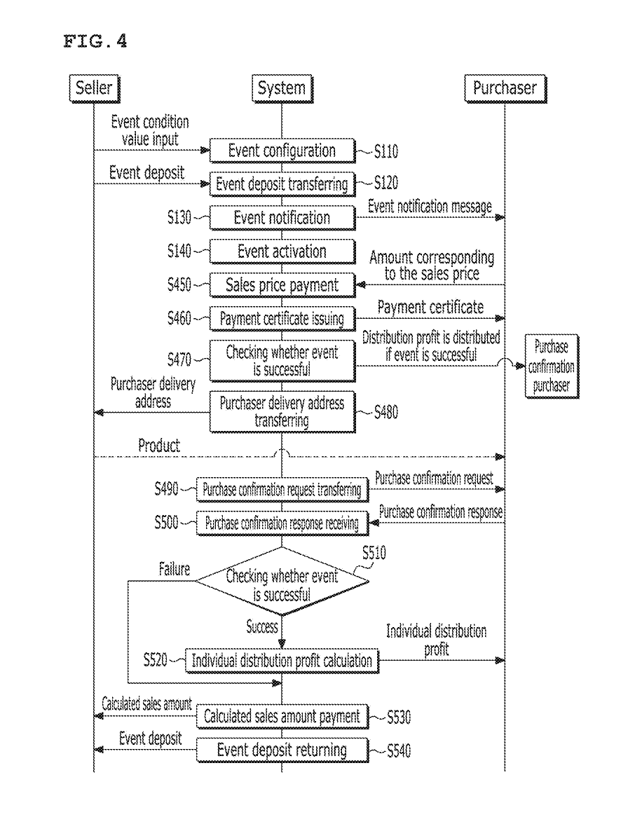

FIG. 4 is an exemplary view showing processes of selling products and distributing sales profit in the product sales promotion system according to an implementation of the disclosed technology, wherein the purchaser makes a payment for the sales price on the event configured by the seller and performs the purchase confirmation response.

Since the steps S110 to S140 are the same as FIG. 2, an explanation on them will be omitted, and accordingly, the step S150 of FIG. 2 (corresponding to step S450 of FIG. 4) and the steps after the step S150 will be in detail explained.

If the event is activated through the event management unit 130 (at the step S140), the purchaser may purchase the product through the purchaser terminal 20. The purchaser may make a payment only for the guaranteed amount or for the whole sales price, and hereinafter, an explanation on the case where the purchaser makes a payment for the sales price will be given.

To purchase the product, the purchaser makes a payment for the sales price on the payment screen provided by the product payment unit 120 through the purchaser terminal 20, and the product payment unit 120 deposits the paid amount of the sales price into the system account unit 150 (at step S450). The paid amount of sales price is the cash withdrawn from the cyber money account or cash account of the purchaser, card sales amount received from a credit card company of the purchaser, and payment amount received from a smart phone communication company of the purchaser. The payment may be made online or offline, and a detailed explanation on the payment will be omitted.

If the payment for the sales price is made, the event management unit 130 issues the payment certificate and transfers the payment certificate to the purchaser terminal 20 (at step S460).

Whenever the event management unit 130 issues the payment certificates for the respective purchasers, it checks whether the event is successful (at step S470). As the target amount of product sales is equal to or less than the total payment made by the purchasers for the sales price, it may be checked whether the event is successful. If it is checked that the event is successful, the product sales promotion system 100 proceeds to distribute the distribution profit to appropriate purchasers.

The delivery management unit 170 transfers a delivery address and a payment certificate for the purchaser (hereinafter, referred to as “sales price payment purchaser”) who makes a payment for the sales price to the seller terminal 10 to allow the seller to deliver the product to the sales price payment purchaser (at step S480). A delivery way includes a delivery service and a direct delivery to the purchaser, and if the product is delivered directly to the purchaser, the seller scans bar codes on the payment certificate provided by the sales price payment purchaser. After the sales price payment purchaser is identified, accordingly, the product is given to the sales price payment purchaser.

The purchase confirmation management unit 180 transfers the purchase confirmation request to the sales price payment purchaser who receives the product through the delivery service or directly receives the product from the seller (at step S490).

The purchase confirmation management unit 180 receives the response to the purchase confirmation request from the sales price payment purchaser (at step S500). The response to the purchase confirmation request is either the purchase confirmation response or the purchase cancel response. Hereinafter, an explanation on the case where the response to the purchase confirmation request is the purchase confirmation response will be given.

If the purchase confirmation management unit 180 receives the purchase confirmation response from the sales price payment purchaser, the event management unit 130 checks whether the event is successful (at step S510). If the event management unit 130 checks that the total amount the number of payment certificates issued by the payments (inclusive of the sales price payments and the guaranteed amount payments) for the products reaches the target amount of product sales, it is determined that the event is successful, and the profit distribution unit 140 pays an individual distribution profit calculated from the distribution profit, in cyber money, to the sales price payment purchaser who performs the purchase confirmation response (at step S520). The profit distribution unit 140 applies the distribution way of the distribution profit and the distribution rate of the distribution profit to the distribution profit to calculate the individual distribution profit. The individual distribution profit is withdrawn from the amount kept in the system account unit 150 and is transferred into the cyber money account of the sales price payment purchaser who performs the purchase confirmation response. The distribution profit is paid in cyber money, but it is possible that the distribution profit is transferred in cash into the cash account of the sales price payment purchaser who performs the purchase confirmation response.

After the individual distribution profit is paid through the profit distribution unit 140 (at the step S520), the event management unit 130 transfers the sales amount calculated by subtracting the sum of the paid individual distribution profits from the total sales amount (calculated by multiplying the sales price and the number of purchase confirmed products) into the cash account of the seller (at step S530) and returns the event deposit in the system account unit 150 to the cash account of the seller (at step S540). In this case, an explanation on the steps S510, S520, S530, and S540 which are sequentially performed is paid, but the steps may be performed concurrently or in a reverse order to each other.

If it is checked by the event management unit 130 that the number of payment certificates issued by the payments (inclusive of the sales price payments and the guaranteed amount payments) for the products does not reach the target amount of product sales (at the step S510), it is determined that the event fails. If the event fails, the step of distributing the individual distribution profit (at the step S520) is not performed.

If the event fails, the event management unit 130 transfers the total sales amount (calculated by multiplying the sales price and the number of purchase confirmed products) into the cash account of the seller (at the step S530) and returns the event deposit in the system account unit 150 to the cash account of the seller (at the step S540). In this case, an explanation on the steps S510, S530 and S540 which are sequentially performed is paid, but the steps may be performed concurrently or in a reverse order to each other.

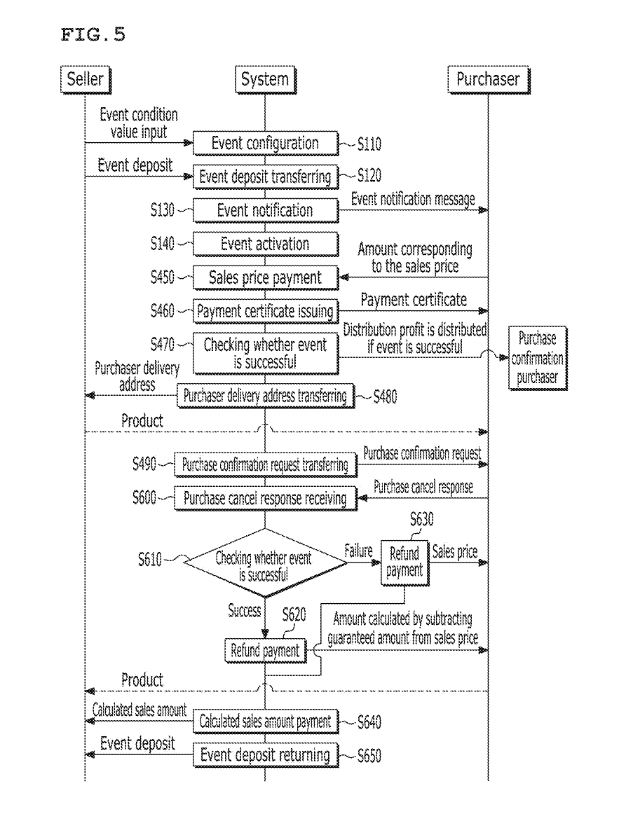

FIG. 5 is an exemplary view showing the case where the purchase confirmation management unit 180 at the step S500 of FIG. 4 receives the purchase cancel response from the sales price payment purchaser, wherein since the steps S110 to S140 and the steps S450 to S490 are the same as FIG. 4, an explanation on them will be avoided, and accordingly, the step S500 of FIG. 4 (corresponding to step S600 of FIG. 5) and the steps after the step S500 will be in detail explained.

The purchase confirmation management unit 180 transfers the purchase confirmation request to the sales price payment purchaser (at the step S490).

The purchase confirmation management unit 180 receives the response to the purchase confirmation request from the sales price payment purchaser (at step S600). The response to the purchase confirmation request is either the purchase confirmation response or the purchase cancel response. Hereinafter, an explanation on the case where the response to the purchase confirmation request is the purchase cancel response will be given. The purchase cancel response is the purchaser's willingness to get a refund.

If the purchase confirmation management unit 180 receives the purchase cancel response from the sales price payment purchaser (at the step S600), the event management unit 130 checks whether the event is successful (at step S610). If the event management unit 130 checks that the number of payment certificates issued by the payments (inclusive of the sales price payments and the guaranteed amount payments) for the products reaches the target amount of product sales, it is determined that the event is successful, and if the event management unit 130 checks that the number of payment certificates issued does not reach the target amount of product sales, it is determined that the event fails.

If the event is successful, the profit distribution unit 140 pays the amount calculated by subtracting the guaranteed amount from the sales price, as s refund, to the sales price payment purchaser who performs the purchase cancel response (at step S620). The refund is withdrawn from the amount kept in the system account unit 150 and is thus transferred into the cash account of the sales price payment purchaser who performs the purchase cancel response. The reason why the guaranteed amount is subtracted from the sales price is that it can be used to pay the distribution profit according to the event success to other purchasers who perform the purchase confirmation response. If the sales price payment purchaser performs the purchase cancel even upon the event success, his or her guaranteed amount is lost, which makes it difficult for he or she to cancel the purchase.

After the profit distribution unit 140 pays the individual distribution profits to the purchasers who perform the purchase confirmation response, the event management unit 130 pays the sales amount calculated by subtracting the sum of the paid individual distribution profits from the total sales amount (calculated by multiplying the sales price and the number of purchase confirmed products) to the cash account of the seller (at step S640) and returns the event deposit in the system account unit 150 to the cash account of the seller (at step S650).

In this case, the purchase confirmation management unit 180 receives the purchase cancel response from the sales price payment purchaser (at the step S600), and after the event management unit 130 checks that the event is successful (at the step S610), the profit distribution unit 140 pays the refund calculated by subtracting the guaranteed amount from the sales price to the sales price payment purchaser who performs the purchase cancel response (at the step S620). If the purchase confirmation management unit 180 receives the purchase cancel response from the sales price payment purchaser, however, the profit distribution unit 140 directly pays the refund calculated by subtracting the guaranteed amount from the sales price to the sales price payment purchaser who performs the purchase cancel response, and then, the event management unit 130 checks whether the event is successful. If it is checked that the event is successful, the guaranteed amount is not additionally paid to the sales price payment purchaser who performs the purchase cancel response. The guaranteed amount is just paid to the purchaser.

If the event fails (at the step S610), the profit distribution unit 140 pays the amount corresponding to the sales price as a refund to the sales price payment purchaser who performs the purchase cancel response (at step S630). The refund is withdrawn from the amount kept in the system account unit 150 and is thus transferred into the cash account of the sales price payment purchaser who performs the purchase cancel response. The reason why the guaranteed amount is not subtracted from the sales price is opposite to the reason why the guaranteed amount is subtracted from the sales price upon the event success.

The event management unit 130 pays the total sales amount (calculated by multiplying the sales price and the number of purchase confirmed products) to the cash account of the seller (at the step S640) and returns the event deposit in the system account unit 150 to the cash account of the seller (at the step S650).

In this case, the purchase confirmation management unit 180 receives the purchase cancel response from the sales price payment purchaser (at the step S600), and after the event management unit 130 checks that the event fails (at the step S610), the profit distribution unit 140 pays the refund corresponding to the sales price to the sales price payment purchaser who performs the purchase cancel response (at the step S630). If the purchase confirmation management unit 180 receives the purchase cancel response from the sales price payment purchaser, however, the profit distribution unit 140 firstly pays the refund (calculated by subtracting the guaranteed amount from the sales price) to the sales price payment purchaser who performs the purchase cancel response, and then, the event management unit 130 checks whether the event is successful. If it is checked that the event fails, the guaranteed amount is secondarily paid to the sales price payment purchaser who performs the purchase cancel response.

An expected distribution order in the product sales promotion system and method according to an implementation of the disclosed technology may be calculated even before the purchase confirmation responses of the guaranteed amount payment purchasers and the sales price payment purchasers are completed. Whenever the payment certificates are issued by the event management unit 130, the profit distribution unit 140 calculates the expected distribution order of the guaranteed amount payment purchasers and the sales price payment purchasers in real time to transfer the real time expected distribution order to the terminals 20 of the guaranteed amount payment purchasers and the sales price payment purchasers.

In this case, of course, the profit distribution unit 140 does not publish the real time expected distribution order until the event is successful, and after the event is successful, the profit distribution unit 140 may transfer the real time expected distribution order to the terminals 20 of the guaranteed amount payment purchasers and the sales price payment purchasers. Until the event is successful, as a result, the guaranteed amount payment purchasers and the sales price payment purchasers cannot obtain the information on their real time expected distribution order, so that such uncertainty in the real time expected distribution order makes purchase desires more stimulated, thereby allowing the event to be successful within more rapid period of time.

The distribution way of the distribution profit in the product sales promotion system and method according to an implementation of the disclosed technology may be selected freely by the seller. For example, the distribution way of the distribution profit is determined according to the order of payment (that is, the payment certificate issue order), an amount of cyber money retained, the order of sales price payment, or the order of purchase confirmation response.

The distribution way of the distribution profit according to the order of payment is carried out by arranging the purchasers (hereinafter, referred to as “purchase confirmation purchasers”) who perform the purchase confirmation responses in the order of payment. In this case, the payment includes both of the guaranteed amount payment and the sales price payment. First, a first individual distribution profit calculated by multiplying the distribution profit and a distribution profit distribution rate is paid to a first purchase confirmation purchaser who performs the most rapid payment among the purchase confirmation purchasers, and next, a second individual distribution profit calculated by multiplying the amount remaining by subtracting the first individual distribution profit from the distribution profit and the distribution profit distribution rate is paid to a second purchase confirmation purchaser who performs the most rapid payment in second order among the purchase confirmation purchasers.

The distribution way of the distribution profit according to the amount of cyber money retained is carried out by arranging the purchase confirmation purchasers in the order according to values (hereinafter, referred to as “cyber money amount for order”) calculated by multiplying the cyber money amount of the cyber money accounts assigned to the accounts of the purchase confirmation purchasers and the number of payment certifications issued to the purchase confirmation purchasers. In this case, at least one selected from the group of the cyber money that is obtained by exchanging the cash of the purchase confirmation purchaser, the cyber money deposited as distribution profit from other events and the cyber money generated by activities of the member joined in the product sales promotion system 100 may be included in the cyber money account. First, a first individual distribution profit calculated by multiplying the distribution profit and a distribution profit distribution rate is paid to a first purchase confirmation purchaser who has the largest cyber money amount for order among the purchase confirmation purchasers, and next, a second individual distribution profit calculated by multiplying the amount remaining by subtracting the first individual distribution profit from the distribution profit and the distribution profit distribution rate is paid to a second purchase confirmation purchaser who has the largest cyber money amount for order in the second order among the purchase confirmation purchasers. For example, if one purchase confirmation purchaser receives five payment certificates, the cyber money amount for order of the purchase confirmation purchaser is calculated as “the amount of cyber money retained*5.”

The distribution way of the distribution profit according to the order of sales price payment is carried out by arranging the purchase confirmation purchasers in the order of sales price payment. In this case, the sales price payment includes both of the sales price payment after the payment of the guaranteed amount and the sales price payment having no guaranteed amount payment. First, a first individual distribution profit calculated by multiplying the distribution profit and a distribution profit distribution rate is paid to a first purchase confirmation purchaser who performs the most rapid sales price payment among the purchase confirmation purchasers, and next, a second individual distribution profit calculated by multiplying the amount remaining by subtracting the first individual distribution profit from the distribution profit and the distribution profit distribution rate is paid to a second purchase confirmation purchaser who performs the most rapid sales price payment in the second order among the purchase confirmation purchasers.

The distribution way of the distribution profit according to the order of purchase confirmation response is carried out by arranging the purchase confirmation purchasers in the order of purchase confirmation response. First, a first individual distribution profit calculated by multiplying the distribution profit and a distribution profit distribution rate is paid to a first purchase confirmation purchaser who performs the most rapid purchase confirmation response among the purchase confirmation purchasers, and next, a second individual distribution profit calculated by multiplying the amount remaining by subtracting the first individual distribution profit from the distribution profit and the distribution profit distribution rate is paid to a second purchase confirmation purchaser who performs the most rapid purchase confirmation response in the second order among the purchase confirmation purchasers.

In the distribution ways of the distribution profit as mentioned above, examples only for the first and second purchase confirmation purchasers are suggested, but in the same manner as above, individual distribution profits are of course paid to the purchase confirmation purchasers in the post-order. For example, a third individual distribution profit calculated by multiplying the amount remaining by subtracting the first individual distribution profit and the second individual distribution profit from the distribution profit and the distribution profit distribution rate is paid to a third purchase confirmation purchaser.

If the distribution profit remains even after the individual distribution profits are paid to all of the purchase confirmation purchasers, the distribution profit calculated by multiplying the remaining distribution profit and the distribution profit distribution rate is paid to the purchase confirmation purchasers again in the order of the purchase confirmation response in the same manner as above. If the remaining distribution profit is less than a given amount, however, the profit distribution unit 140 transfers the remaining distribution profit into the system account unit 150 and finishes the distribution of the distribution profit.

Now, an explanation on the effects obtained by the product sales promotion system and method according to an implementation of the disclosed technology will be given with a given example.

Any one sales agency of a computer manufacturing company A sells a laptop computer X for a retail price of 2,000 dollars. The average number of laptop computers X sold for a month in the sales agency is 50. Actually, the laptop computer is sold at the lowest price of 1,800 dollars on on-line markets.

The sales agency determines that they sell the laptop computer X for 1,800 dollars, which is the lowest price on on-line markets, through the product sales promotion system 100 according to an implementation of the disclosed technology, and the event is configured with the following conditions.
Sales price: 1,800 dollars
Target period of product sales: one month
Target number of computers sold: 2,000
Guaranteed amount: 20 dollars
Distribution profit to be distributed to purchasers if the event is successful: 780,000 dollars
Distribution way of distribution profit: distribution according to the amounts of cyber money retained in the cyber money accounts of purchase confirmation purchasers
Distribution rate of distribution profit: 0.1%

The sales agency can accomplish the number of laptop computers X sold which is more increased by 40 times than the number of laptop computers X sold for one month in the past, for only one month, which is the same period as in the past, so that the sales agency obtains additional cash of 3,510,000 dollars (=1,800 dollars*1,950) greater than cash of 100,000 dollars for one month in the past. The distribution profit of 780,000 dollars corresponding to about 22% of the additional cash is distributed to the purchasers (If it is desired for the sales agency to sell 1,950 laptop computers X in the conventional manner, a period of three years and three months is needed).

A purchaser B is a first purchaser having the largest cyber money account amount among the 2,000 purchasers, a purchaser C is a second purchaser having the largest cyber money account amount in the second order among the purchasers, a purchaser D is a 500th purchaser having the largest cyber money account amount in the 500th order among the purchasers, and a purchaser E is a 2000th purchaser having the largest cyber money account amount in the 2000th order among the purchasers. In this case, the cyber money to be distributed to the purchasers B, C, D and E will be calculated as follows.

Individual distribution profit of 780 dollars(=distribution profit of 780,000 dollars*distribution rate of distribution profit of 0.1%) [Amount to be Paid to Purchaser B]

Individual distribution profit of 779 dollars(=amount of 779,220 dollars calculated by subtracting the first individual distribution profit of 780 dollars from distribution profit of 780,000 dollars*distribution rate of distribution profit of 0.1%) [Amount to be paid to purchaser C]

Individual distribution profit of 473 dollars(=amount of 473,449 dollars calculated by subtracting the individual distribution profits of up to 499th purchasers from distribution profit of 780,000 dollars*distribution rate of distribution profit of 0.1%) [Amount to be paid to purchaser D]

Individual distribution profit of 106 dollars(=amount of 105,562 dollars calculated by subtracting the individual distribution profits of up to 1999th purchasers from distribution profit of 780,000 dollars*distribution rate of distribution profit of 0.1%) [Amount to be paid to purchaser E]

The guaranteed amount of 20 dollars is paid back to the purchasers B, C, D and E, respectively, and the purchasers B, C, D and E purchase the laptop computer X of 1,800 dollars, which is the lowest price on on-line markets. According to the event success, furthermore, the purchasers B, C, D and E have got the respective individual distribution profits of 780 dollars, 779 dollars, 473 dollars, and 106 dollars in the form of cyber money. With a payment of the withdrawal fee, the cyber money in the cyber money account can be transferred into the cash account or cash can be withdrawn directly from the cyber money account, thereby increasing the cash assets of the purchaser. Further, since the order of the cyber money retention of the purchaser is raised by the cyber money distributed through this purchase, a larger amount of individual distribution profit can be distributed to the purchaser at the time of next purchase.

If the payment of the purchaser is made through the use of an interest-free installment program provided by a credit card company, the profit of the purchaser will be maximized. If the purchaser buys a 2,000 dollar laptop computer in the conventional purchase system, he or she just prepares 2,000 dollars, which makes him or her feel burdened so that he or she does not purchase the laptop computer. Through the product sales promotion system 100, the sales price is paid in interest-free installments, and next, the installment amount is paid with the individual distribution profit, thereby making the purchase burden of the purchase disappear. Such an advantage is obtained because the value of time is turned into the cyber money. Particularly, if the distribution rate of the distribution profit is raised by the seller, the amount of the distribution profit to be distributed to the top-order purchasers is increased, so that the consumption willingness and event join willingness of the members become high. An example of such a case will be explained later.

For a short period of time, of course, the seller accomplishes a substantially larger amount of sales than an amount of sales in the past, thereby obtaining a great sales profit, and even if the distribution profit is distributed, an amount of sales over several months to years can be obtained within the short period of time, so that no damage occurs. So as to improve the possibility of event success, further, if the distribution profit or the distribution rate of the distribution profit is raised by the seller, the event join desires of the members can be strongly stimulated, thereby rapidly and reliably achieving the target amount of product sales.

The product sales promotion system 100 can obtain profits with the system usage fee received from the seller when the event is activated by the seller and with the withdrawal fees received from the members when the cyber money is withdrawn from the cyber money accounts by the members. Further, if the number of events activated by numerous sellers over the world is uncountably large, the cash balance in the system account unit 150, which is obtained by the events, is kept to a very large amount of money. Therefore, a cyber money mortgage or secondary outsourcing investment can be conducted by means of the use of the system usage fees, the withdrawal fees, and the cash balance in the system account, thereby creating great profits.

The members withdraw the cyber money from their cyber money accounts and encash the cyber money, or they get a loan against their cyber money from the product sales promotion system 100. The members can encash their cyber money with a payment of the withdrawal fees, but in this case, an amount of cyber money retained in the cyber money account is decreased to cause the distribution order of the distribution profit of the event to be undesirably lowered. So as to perform the encashing of the cyber money in the state where the amount of cyber money retained is kept, accordingly, the product sales promotion system 100 pays in cash of the system account unit 150 for the loaned money against the cyber money of the members. As a result, the product sales promotion system 100 does a financial business.

Now, an explanation on more improved effects obtained by increasing the distribution profit and the distribution rate of the distribution profit through the seller in the product sales promotion system 100 and method according to an implementation of the disclosed technology will be given with a given example.

A famous fitness center A has sold a three-year membership X for a retail price of 3,000 dollars. The maximum number of three-year memberships X sold for a day in the fitness center A is 10. Actually, the three-year membership X is sold at the lowest price of 2,800 dollars on on-line markets, and the sales profit obtained when one three-year membership X is sold in the fitness center A is 1,650 dollars.

The fitness center A determines that they sell the three-year membership X for 2,800 dollars, which is the lowest price on on-line markets, through the product sales promotion system according to an implementation of the disclosed technology, and the event is configured with the following conditions.
Sales price: 2,800 dollars
Target period of product sales: one day
Target number of memberships sold: 1,000
Guaranteed amount: 1,300 dollars
Distribution profit to be distributed to purchasers if the event is successful: 1,300,000 dollars
Distribution way of distribution profit: distribution according to the payment order of purchase confirmation purchasers
Distribution rate of distribution profit: 0.6%

The fitness center A can accomplish the number of memberships sold that is more increased by 100 times than the number of memberships sold for one day in the past, for only one day, which is the same period as in the past, so that the fitness center A obtains additional cash of 2,772,000 dollars (=2,800 dollars*990) greater than cash of 30,000 dollars for one day in the past.

Further, the fitness center A obtains additional sales profit of 1,633,500 dollars (=1,650 dollars*990) greater than a sales profit of 16,500 dollars for one day in the past.

The distribution profit of 1,300,000 dollars corresponding to about 78% of the additional sales profit is distributed to the purchasers (If it is desired for the fitness center to sell 990 three-year memberships in the conventional manner, a period of at least about three months is needed, and even after about the three months, of course, selling of the 990 three-year memberships cannot be ensured).

A purchaser B is a first purchaser who is in the first payment order among the 1,000 purchasers, a purchaser C is a second payment order, a purchaser D is in the 500th payment order, and a purchaser E is in 1,000th payment order. In this case, the cyber money to be distributed to the purchasers B, C, D and E will be calculated as follows.

Individual distribution profit of 7,800 dollars(=distribution profit of 1,300,000 dollars*distribution rate of distribution profit of 0.6%) [Amount to be paid to purchaser B]

Individual distribution profit of 7,753 dollars(=amount of 1,292,200 dollars calculated by subtracting the first individual distribution profit of 7,800 dollars from distribution profit of 1,300,000 dollars*distribution rate of distribution profit of 0.6%) [Amount to be paid to purchaser C]

Individual distribution profit of 387 dollars(=amount of 64,528 dollars calculated by subtracting the individual distribution profits of up to 499th purchasers from distribution profit of 1,300,000 dollars*distribution rate of distribution profit of 0.6%) [Amount to be paid to purchaser D]

Individual distribution profit of 19 dollars(=amount of 3,184 dollars calculated by subtracting the individual distribution profits of up to 999th purchasers from distribution profit of 1,300,000 dollars*distribution rate of distribution profit of 0.6%) [Amount to be paid to purchaser E]

The guaranteed amount of 1,300 dollars is paid back to the purchasers B, C, D and E, respectively, and the purchasers B, C, D and E purchase the three-year memberships of 2,800 dollars, which is the lowest price on on-line markets. According to the event success, furthermore, the purchasers B, C, D and E have got the respective individual distribution profits of 7,800 dollars, 7,753 dollars, 387 dollars, and 19 dollars in the form of cyber money.

With a payment of the withdrawal fee, the cyber money in the cyber money account may be transferred into the cash account or cash may be withdrawn directly from the cyber money account, thereby increasing the cash assets of the purchaser. Further, the purchasers B and C who in the first and second distribution order of the distribution profit can earn a great amount of money, even if the price of the three-year membership is subtracted from the distribution profit. Their wealth is increased through their consumption.

Through the two examples as mentioned above, it can be appreciated that the product sales promotion system 100 according to an implementation of the disclosed technology provides a consuming-tech (consumption+financial technology) system that increases wealth through consumption, and as large consumption is made, wealth is increased, so that consumption, deal and turnover ratio are optimized to achieve the advancement into a new economic paradigm unlike the conventional economic paradigm.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve described results. Moreover, the separation of various system components in the embodiments described in this patent document should not be understood as requiring such separation in all embodiments. Only a few implementations and examples are described. Other implementations, enhancements and variations can be made based on what is described and illustrated in this patent document.

What is claimed is:

1. A product sales promotion system comprising:
an event configuration unit adapted to receive sales event information from a seller terminal, the sales event information including at least one of sales price of a product, a target period of time for product sales, or a target amount of product sales;
a product payment unit adapted to receive payments from purchaser terminals of purchasers;
an event management unit adapted to activate a sale event based on the sales event information, the event management unit further adapted to check whether the sales event is successful or not based on a comparison between the payments received by the product payment unit and the target amount of product sales; and
a profit distribution unit adapted to provide, to a group of purchasers, individual distribution profits when the event management unit determines that the event is successful, the individual distribution profit distributed to each purchaser in the group being a portion of a distribution profit,
wherein the event configuration unit is further configured to receive, from the seller terminal, a distribution way of the distribution profit and a distribution rate of the distribution profit.

2. The product sales promotion system according to claim 1, wherein, before the event is activated, the event management unit transfers an event notification message of notifying a member enrolled in the product sales promotion system of a start date and a start time of the sales event.

3. The product sales promotion system according to claim 1, wherein the event management unit activates the sales event after a given period of a standby time from a start time of the event activation.

4. The product sales promotion system according to claim 1, wherein the event configuration unit is further configured to receive a guaranteed amount of the product that is less than the sales price of the product from the seller terminal, and the payment received by the event management unit from each purchaser is either the sales price of the product or the guaranteed amount of the product.

5. The product sales promotion system according to claim 4, further comprising:
a system account unit for depositing the payments; and
a member account unit provided to a member enrolled in the product sales promotion system to deposit at least one of cyber money or cash.

6. The product sales promotion system according to claim 5, wherein before or at the same time the event activation starts, the system account unit receives an event deposit from the seller terminal.

7. The product sales promotion system according to claim 6, wherein, if the payment received from a particular purchaser is the guaranteed amount of the product, the event management unit transfers an additional payment request to the particular purchaser and when the particular purchaser makes an additional payment as much as the sales price of the product, the product sales promotion system returns the payment for the guaranteed amount to the particular purchaser.

8. The product sales promotion system according to claim 1, further comprising a delivery management unit for transferring, to the seller terminal, delivery information including a delivery address of a purchaser.

9. The product sales promotion system according to claim 1, further comprising a purchase confirmation management unit for transferring a purchase confirmation request to each of some of the purchasers to receive responses to the purchase confirmation request from the some of the purchasers.

10. The product sales promotion system according to claim 9, wherein when the response to the purchase confirmation request is a purchase cancel response, the distribution unit operates to refund different amounts to target purchasers who has made a payment but canceled a purchase, the different amounts depending on whether the event management unit determines that the sales event is successful or not, whether a target purchaser has paid the sales price of the product or the guaranteed amount of the product.

11. The product sales promotion system according to claim 10, wherein the profit distribution unit refunds (1) an amount calculated by subtracting the guaranteed amount from the sales price and further refunds (2) the guaranteed amount of the product only when the event management unit determines that the sales event is not successful.

12. The product sales promotion system according to claim 1, further comprising a minimum guaranteed amount calculation unit for notifying the seller terminal of a minimum value for the guaranteed amount, the minimum value being calculated by dividing a greatest individual distribution profit among the individual distribution profits by the target amount of product sales.

13. The product sales promotion system according to claim 1, further comprising a minimum guaranteed amount calculation unit for notifying the seller terminal of a minimum value for the guaranteed amount, the minimum value being calculated by dividing the event deposit by the target amount of product sales.

14. The product sales promotion system according to claim 1, wherein the distribution profit is distributed by the distribution way including the steps of:
arranging an order of the purchasers based on a timing of each payment;
paying a first individual distribution profit calculated by multiplying the distribution profit and the distribution rate for a first purchase confirmation purchaser who has made the earliest payment among the purchasers; and
paying a second individual distribution profit calculated by multiplying an remaining distribution profit obtained by subtracting the first individual distribution profit from the distribution profit and the distribution rate for a second purchase confirmation purchaser who has made the payment later than the first purchase confirmation purchaser but earlier than remaining purchasers.

15. The product sales promotion system according to claim 5, wherein the member account unit comprises a cyber money account in which cyber money is deposited, and the distribution profit is distributed by the distribution way comprising the steps of:
arranging an order of the purchasers based on a value calculated by multiplying a cyber money amount of each purchaser and the number of total payment of each purchaser;
paying a first individual distribution profit calculated by multiplying the distribution profit and the distribution rate for a first purchase confirmation purchaser whose value is greatest among the purchasers; and
paying a second individual distribution profit calculated by multiplying a remaining distribution profit obtained by subtracting the first individual distribution profit from the distribution profit and the distribution rate for a second purchase confirmation purchaser whose value is the second greatest among the purchasers.

16. The product sales promotion system according to claim 4, wherein the distribution profit is distributed by the distribution way comprising the steps of:
arranging an order of the purchasers based on a sales price payment made by each purchaser for the sales price of the product, the sales price payment not including a payment for the guaranteed amount;
paying a first individual distribution profit calculated by multiplying the distribution profit and the distribution rate for a first purchase confirmation purchaser who has made the earliest sales price payment among the purchasers; and
paying a second individual distribution profit calculated by multiplying an remaining distribution profit obtained by subtracting the first individual distribution profit from the distribution profit and the distribution rate for a second purchase confirmation purchaser who has made the sales price payment later than the first purchase confirmation purchaser but earlier than remaining purchasers.

17. The product sales promotion system according to claim 9, wherein the distribution profit is distributed by the distribution way comprising the steps of:
arranging an order of the purchasers based on timings of receipts of the purchase confirmation responses from the some of the purchasers;
paying a first individual distribution profit calculated by multiplying the distribution profit and the distribution rate for a first purchase confirmation purchaser who has made the earliest purchase confirmation response among the purchasers; and
paying a second individual distribution profit calculated by multiplying a remaining amount obtained by subtracting the first individual distribution profit from the distribution profit and the distribution rate for a second purchase confirmation purchaser who has made the payment later than the first purchase confirmation purchaser but earlier than remaining purchasers.

18. The product sales promotion system according to claim 5, wherein the profit distribution unit transfers, to the purchasers, an expected distribution order indicating an order of the purchasers in the group to receive the individual distribution profits according to the distribution way of the distribution profit.

19. The product sales promotion system according to claim 18, wherein the expected distribution order is determined based on a value obtained by multiplying cyber money amount deposited in the member account unit and the number of payments.

20. The product sales promotion system according to claim 18, further comprising a purchase confirmation management unit for transferring a purchase confirmation request to each of some of the purchasers to receive responses to the purchase confirmation request from the some of the purchasers, and wherein the expected distribution order is determined based on timings of receipts of the purchase confirmation responses from the some of the purchasers.
